(19) United States
(12) Patent Application Publication
(10) Pub. No.: US 2016/0122690 A1
(43) Pub. Date: May 5, 2016

(54) Particulate Enzyme Composition

(71) Applicant: NOVOZYMES A/S, Bagsvaerd (DK)

(72) Inventors: Dennis Bonne, Vanloese (DK); Yitong Liu, Beijing (CN)

(73) Assignee: NOVOZYMES A/S, Bagsvaerd (DK)

(21) Appl. No.: 14/893,823

(22) PCT Filed: May 6, 2014
(86) PCT No.: PCT/EP2014/059235

§ 371 Date: Nov. 24, 2015

(30) Foreign Application Priority Data
May 30, 2013 (EP) 13169852.4

(51) Int. Cl. C11D 3/386; C11D 17/06; C11D 17/00

(52) U.S. Cl. CPC C11D 3/38609; C11D 17/0039; C11D 17/06

(57) ABSTRACT

A mixture of slow-release and fast-release enzyme particles provides an improved enzyme effect in solution compared to the individual enzyme particles.

### FIELD OF THE INVENTION

The present invention relates to a particulate composition comprising enzyme-containing particles. More particularly, it relates to a composition with improved enzyme performance in solution.

### BACKGROUND OF THE INVENTION

Enzyme particles are commonly used in particulate compositions, e.g. in granular detergents where the enzyme in the wash solution serves to improve the removal of stains and soils. The particulate composition may contain aggressive ingredients which adversely affect the enzyme in solution. Thus, enzymes such as amylases may be degraded in a solution by aggressive detergent components such as a bleach system.

One way of mitigating the problem of enzyme degradation is to provide the enzyme in the form of slow-release particles so that the release of the enzyme to the solution is delayed relative to the release of the aggressive ingredient. WO 95/28469, U.S. Pat. No. 5,733,763, WO 2012/175401 and WO 2013/003025 disclose coated enzyme particles.

### SUMMARY OF THE INVENTION

The inventors have found that a mixture of slow-release and fast-release enzyme particles can provide a better enzyme effect in solution than each kind of enzyme particles separately. Accordingly, the invention provides a particulate enzyme composition comprising:
a) 10-90% by weight of slow-release (or delayed-release) enzyme-containing particles (A) and
b) 10-90% by weight of fast-release enzyme-containing particles (B),
   wherein the slow-release particles (A) have a release time for the enzyme which is at least two times the release time of the fast-release particles (B), and wherein particles (A) and (B) comprise the same enzyme which is an amylase, a carbohydrase, a protease, a cutinase, a cellulase, an oxidoreductase, a mannanase or a pectate lyase.

The invention also provides a particulate bleach-containing detergent composition comprising the particulate enzyme composition.

### DETAILED DESCRIPTION OF THE INVENTION

### Enzymes

The slow-release particles (A) and the fast-release particles (B) comprise the same enzyme which is an amylase, a carbohydrase, a protease, a cutinase, a cellulase, an oxidoreductase, a mannanase or a pectate lyase.

On average, particles (A) and particles (B) typically include between about 0.005 to about 500 mg/g on a dry weight basis of the enzyme component relative to the core (as active enzyme protein). For instance, the amount of enzyme in the particles may be about 0.05 to 300 mg/g, about 0.1 to 250 mg/g, about 0.5 to 200 mg/g, about 0.5 to 200 mg/g, about 1.0 to 150 mg/g in the particle, or about 5.0 to 150 mg/g.

Amylase. The amylase may be an a-amylase obtained from Bacillus, e.g. B. subtilis or B. licheniformis, in particular the amylase from a special strain of B. licheniformis, described in more detail in GB 1,296,839.

Examples of useful amylases are described in WO 94/02597, WO 94/18314, WO 1995/010603, WO 1995/026397, WO 96/23873, WO 97/43424, and WO 00/60060, WO 2001/066712, WO 2006/002643, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

In a particular embodiment the alpha-amylase is derived from Bacillus sp. strains NCIB 12289, NCIB 12512, NCIB 12513 and DSM 9375. Especially preferred are the alpha-amylases shown in SEQ ID NOS 1 and 2 of WO 95/26397.

Commercially available amylases are NATALASE™, STAINZYME™, STAINZYME PLUS™, TERMAMYL™ ULTRA, DURAMYL™, TERMAMYL™, FUNGAMYL™ and BAN™ (Novozymes A/S), RAPIDASE™, PURASTAR™ and PURASTAR OXAM™ (from Genencor International Inc.).

Protease. Suitable proteases include those of animal, vegetable or microbial origin. Microbial origin is preferred, e.g. bacterial or fungal. Chemically modified or protein engineered mutants are included. The protease may be an alkaline protease, such as a serine protease or a metalloprotease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are trypsin (e.g., of porcine or bovine origin) and the Fusarium protease described in WO 89/06270 and WO 94/25583.

Cutinases: Suitable cutinases include those of bacterial or fungal origin. Chemically modified or protein engineered mutant enzymes are included. Examples include cutinase from Humicola, e.g. H. insolens (WO96/13580), cutinase from Magnaporthe grisea (WO10/107560), and cutinase from Pseudomonas mendocina (U.S. Pat. No. 5,389,536).

Cellulase. Suitable cellulases include complete cellulases or mono-component endoglucanases of bacterial or fungal origin. Chemically or genetically modified mutants are included. The cellulase may for example be a mono-component or a mixture of mono-component endo-1,4-beta-glucanase often just termed endoglucanases (EC 3.2.1.4). Some xyloglucanases may also have endoglucanase activity and are also considered as suitable cellulases in the present invention. Suitable cellulases are disclosed in U.S. Pat. No. 4,435,307, which discloses fungal cellulases produced from Humicola insolens. Especially suitable cellulases are the cellulases having textile care benefits. Examples of such cellulases are cellulases described in European patent application No. 0 495 257.

Pectate lyase. The pectate lyase may be a wild-type enzymes derived from Bacillus, particularly B. licherniformis or B. agaradhaerens, or a variant derived of these, e.g. as described in U.S. Pat. No. 6,124,127 (NZ 5543), WO 1999/027083 (NZ 5377), WO 1999/027084 (NZ 5378), WO 2002/006442 (NZ 10044), WO 2002/092741 (NZ 10171), or WO 2003/095638 (NZ 10190).

Mannanase. The mannanase may be an alkaline mannanase of Family 5 or 26. It may be a wild-type from Bacillus or Humicola, particularly B. agaradhaerens, B. licheniformis, B. halodurans, B. clausii, or H. insolens. Suitable mannanases are described in WO 1999/064619 (NZ 5440).

### Enzyme-Containing Particles

The two kinds of particles (A) and (B) preferably have similar sizes. Thus, the average diameters of particles (A) and (B) may have a ratio of 0.7-1.4. Each of the two kinds of particles preferably has an average diameter of 500-710 μm.

The two kinds of particles (A) and (B) preferably have similar enzyme content. Thus, the enzyme activity of particles (A) and (B) may have a ratio of 0.5-2, particularly 0.7-1.4.

The particulate composition may comprise 40-80% by weight of the slow-release particles (A) and 20-60% by weight of the fast-release particles (B), particularly 50-75% of particles (A) and 25-50% of particles (B).

### Slow-Release Particles (A)

The particles may have a delayed-release coating which comprising a hydrophobic substance, e.g. a high-melting wax or fat, particularly in an amount of 1-50% or 5-15% by weight. The coating may further comprise a water-insoluble substance, e.g. kaolin, talc or calcium carbonate, e.g. in an amount of 60-75% by weight. The coating may constitute 15-35% by weight of the coated particle. The hydrophobic substance may be a fat, wax or paraffin. The coating may be as described in WO 92/12645 or WO 97/16076.

The hydrophobic substance is a substance which is not readily wetted by water, i.e. which tends to repel water. Such substances—examples of which are oils, fats, hydrocarbon waxes and numerous types of resins—are in general essentially completely insoluble in water.

Hydrophobic substances which are of particular relevance in the context of the present invention are normally substances which are soluble in organic solvents of the hydrocarbon type (e.g. hexane, heptane and the like) or chlorinated hydrocarbon type (e.g. dichloromethane, chloroform and the like). Suitable examples hereof include various glyceride lipids (i.e. mono-, di- or triglycerides), such as animal tallow (e.g. beef or mutton tallow) and vegetable oils, and certain derivatives thereof.

Particularly well suited hydrophobic substances are those which are solid at ambient temperature and which have a melting point of about 40° C. or above. Examples hereof include substances such as certain native or hardened (hydrogenated) vegetable oils or fats, e.g. hydrogenated palm oil, hydrogenated palm kernel oil or hydrogenated soya bean oil, as well as materials such as hydrogenated tallow (e.g. hydrogenated beef tallow or mutton tallow). The coating agent comprises a high melting fat or wax, particularly with a melting point between 30 and 100° C. preferably between 40 and 60° C. The fat may be a glycerol ester (mono-, di- or tri-ester or a mixture thereof). The wax may be a waxy substance which is of tough and not brittle nature and possesses substantial plasticity at room temperature.

The paraffin (paraffin wax) is a white or colourless soft solid which may be used as a lubricant and for other applications. It is derived from petroleum and consists of a mixture of hydrocarbon molecules containing between twenty and forty carbon atoms.

In addition to the delayed-release coating, the granules may optionally comprise one or more additional coatings, either as an undercoat or a topcoat, e.g. to reduce dust formation. Such a coating may comprise polyethylene glycol (PEG), polyvinyl alcohol (PVA) or hydroxypropyl methyl cellulose (HPMC).

### Enzyme Release Profiles

The release profiles for the enzyme in the two kinds of particles is such that particles (A) have a release time for the enzyme which is at least two times the release time for particles (B). The release times may be determined as the time required to release 50% or 90% of the enzyme activity, e.g. by the test method described below. The release time for the slow-release particles is preferably at least 1.5 times, at least 2 times or at least 3 times longer than the release time for the fast-release particles. The test to determine whether these values are met is defined as Test Method 2: Dissolution test, below.

The release profile for the enzyme in the slow-release particles is preferably such that the time required to release 50% of the enzyme activity is at least 100 seconds, at least 200 seconds or at least 300 seconds. The time required to release 50% of the enzyme activity may be below 1000 seconds, e.g. below 600 seconds.

### Fast-Release Particles (B)

The fast-release particles may be uncoated or may be coated with a water-soluble polymer, particularly comprises polyethylene glycol (PEG), polyvinyl alcohol (PVA) or hydroxypropyl methyl cellulose (HPMC).

### Test Method: Dissolution Test

A detergent solution is prepared as described in Example 2 of WO 2012/175401. The detergent solution is stirred for 30 min and filtered through a sheet of gauze. The detergent solution is adjusted to 20° C.±2° C. and placed under a 4-bladed propeller stirrer adjusted to 600 rpm±10 rpm. 75 mg enzyme containing particle/I detergent solution is added at T₀. After addition of the enzyme containing particles the concentration of the enzyme released to the detergent solution is measured every 15 seconds for the first 60 seconds by withdrawing samples from the detergent solution. Subsequently samples are taken out every 30 seconds until 120 seconds and every 60 seconds until 1100 seconds. The enzyme activity in the withdrawn samples is measured in a suitable analytical method. The times for 50% and 90% release of the enzyme from the enzyme containing particles are calculated by interpolation or extrapolation of these measurements.

### Detergent Composition

The particulate composition with two kinds of enzyme particles may be included in a particulate bleach-containing detergent composition. This is particularly beneficial if the enzyme is sensitive to the bleach. A bleach-sensitive enzyme may be defined as an enzyme that loses more than 30% wash performance after 14 minutes full scale main wash at 40 ° C. and pH 9.7 with a detergent comprising 10% by weight sodium percarbonate.

### EXAMPLES

### Example 1

### Release Times of Particulate Enzyme Compositions

Two kinds of enzyme particles were prepared from T-granulates produced essentially as in example 1 of WO 2004/003188 (containing enzyme, Na-sulfate, cellulose fibers, calcium carbonate and a binder, e.g. sucrose or dextrin). Enzyme granules with a delayed-release coating of 8% of fully hydrogenated palm oil and 18% of CaCO₃ (in % by weight of the uncoated particles) were prepared as described in Example 1 of WO 2012/175401. Enzyme granules with a conventional coating were prepared by coating with PEG-4000 in an amount of 5%. Savinase™ , Stainzyme™ and Celluclean™ (commercial detergent protease, amylase and cellulase from Novozymes NS) were used. The average diameters of the coated and uncoated particles were 500-710 μm.

The times for 50% and 90% enzyme release by the dissolution test method described above in a model detergent were as follows.

| Sample | Coating | 50% release | 90% release |
|---|---|---|---|
| Savinase | Conventional | 10 sec | 240 sec |
| | Delayed release | — | 7171 sec |
| Stainzyme | Conventional | 90 sec | 316 sec |
| | Delayed release | 360 sec | 1123 sec |
| Celluclean | Conventional | 32 sec | — |
| | Delayed release | 364 sec | 680 sec |

The release times in a commercial detergent were as follows:

| Sample | Coating | 50% release | 90% release |
|---|---|---|---|
| Savinase | Conventional | 78 sec | 313 sec |
| | Delayed release | 784 sec | 3161 sec |

The results demonstrate that a coating comprising a hydrophobic substance and a water-insoluble substance is effective for delaying the release of various enzymes.

### Example 2

### Release Times of Particulate Enzyme Compositions

Enzyme particles were prepared from T-granulates produced essentially as in example 1 of WO 2004/003188 (containing enzyme, Na-sulfate, cellulose fibers, calcium carbonate and a binder, e.g. sucrose or dextrin). Enzyme granules with a delayed-release coating of palm oil and CaCO₃ were prepared as described in Example 1 of WO 2012/175401. Stainzyme™ (commercial detergent amylase from Novozymes NS) was used. The average diameters of the coated and uncoated particles were 500-710 μm.

The times for 50% and 90% enzyme release by the dissolution test method described above in a model detergent were as follows. Percentages indicate amounts in % by weight of the uncoated particles.

| Sample | Coating | 50% release | 90% release |
|---|---|---|---|
| Stainzyme | None | 16 sec | 56 sec |
| Stainzyme | Palm oil 5% | 574 sec | 1577 sec |
| | CaCO₃ 15% | | |
| Stainzyme | Palm oil 10% | 1612 sec | 4273 sec |
| | CaCO₃ 23% | | |
| Stainzyme | Palm oil 15% | 1669 sec | 4697 sec |
| | CaCO₃ 35% | | |
| Stainzyme | Palm oil 20% | 1847 sec | 5672 sec |
| | CaCO₃ 60% | | |

The results demonstrate that increasing amounts of coating comprising a hydrophobic substance and a water-insoluble substance are effective for increasing the delayed enzyme release.

### Example 3

### Wash Performance of Particulate Enzyme Compositions

The two kinds of coated amylase granules prepared in Example 1 were mixed at ratios of delayed-release: conventional (slow/fast release)=3:1 or 1:1. The wash performance of the two mixtures was determined as follows, and compared with the wash performance of the two individual granulates.

Terg-O-Tometer(TOM) is an apparatus that simulates “Top-loader/Vertical Drum” washing machine. The TOM has 16 two liters washing containers each fitted with an agitator.

### TOM Wash Procedure

1. Prepare swatches, ballast, detergent, enzyme and water hardness according to study plan.
2. Transfer deionized water to a bucket, add water hardness to 15° dH, and stir for 1 min.
3. Weight out detergent and add into the bucket. Let stir for 10 minutes.
4. Transfer 1L of fresh detergent dissolution into each TOM beaker.
5. Turn TOM. Set rotation speed (120 rpm or 150 rpm) and washing temperature (40° C.).
6. When temperature is correct, load enzyme (as dry granulate) and swatches/ballast (CS28 and EMPA161) to following beakers every 60 seconds with 30 seconds of interval.
   a. At 0 seconds load swatches to washing beaker 1 (Blank)
   b. After 30 seconds, load enzyme to washing beaker 2, and after 60 seconds load swatches to beaker 2.

7. After 40 minutes wash, take out beakers from TOM, and sort out the swatches.
8. Rinse under cold running tap water for 10min.
9. Dry swatches at room temperature overnight in a dark room.
10. Measure the reflectance of the swatches.

| TOM, dose response | | | |
|---|---|---|---|
| in European | | | |
| powder detergent | | Delta | Delta remissions |
| without enzyme with | | remissions | on EMPA161 |
| bleach, 40° C., 40 min, | Stainzyme | on CS-28 rice | starch porridge |
| 15 dH, 120 rpm | (ppm) | starch (—) | (—) |
| Fast release | 0.05 | 13.8 | 3.9 |
| | 0.1 | 19.2 | 6.8 |
| | 0.2 | 24.6 | 10.1 |
| | 0.4 | 26.3 | 14.8 |
| Mix slow/fast | 0.05 | 21.6 | 7.5 |
| release 1:3 | 0.1 | 25.8 | 11.4 |
| | 0.2 | 25.1 | 13.1 |
| | 0.4 | 27.9 | 16.3 |

| TOM, dose response in | | |
|---|---|---|
| European powder | | |
| detergent without | | Sum of delta remissions |
| enzyme with bleach, | Stainzyme | on CS-28 and |
| 40° C., 40 min, 15 dH, 150 rpm | (ppm) | EMPA161 (—) |
| Fast release | 0.1 | 30.0 |
| | 0.2 | 38.9 |
| Slow release | 0.1 | 29.8 |
| | 0.2 | 36.7 |
| Mix slow/fast release 3:1 | 0.1 | 36.2 |
| | 0.2 | 39.9 |

| TOM, dose | | | |
|---|---|---|---|
| response EMPA161 | | Delta remissions | Delta remissions |
| starch porridge, | | in commercial | in commercial |
| 40° C., 40 min, | Stainzyme | bleach detergent | bleach detergent |
| 15 dH, 120 rpm | (ppm) | #1 | #2 |
| Fast release | 0.05 | 9.8 | 4.4 |
| | 0.1 | 15.0 | 9.1 |
| | 0.2 | 17.7 | 13.3 |
| Mix fast/slow release | 0.05 | 9.3 | 5.8 |
| 1:1 | 0.1 | 16.0 | 10.1 |
| | 0.2 | 20.7 | 14.9 |

The results demonstrate that the mixtures have an improved wash performance compared to the two individual types of enzyme particles.

1. A particulate composition comprising:
a) 10-90% by weight of enzyme-containing particles (A) and
b) 10-90% by weight of enzyme-containing particles (B),
wherein particles (A) have a release time for the enzyme which is at least two times the release time for particles (B), and wherein particles (A) and (B) comprise the same enzyme which is an amylase, a carbohydrase, a protease, a cutinase, a cellulase, an oxidoreductase, a mannanase or a pectate lyase.

2. The particulate composition of claim 1 wherein the release time for particles (A) is at least three times the release time for particles (B), particularly at least five times.

3. The particulate composition of claim 1 which comprises 40-80% by weight of particles (A) and 20-60% by weight of particles (B).

4. The particulate composition of claim 1 which comprises 20-60% by weight of particles (A) and 40-80% by weight of particles (B).

5. The particulate composition of claim 1 wherein particles (A) and particles (B) have average diameters at a ratio of 0.7-1.4.

6. The particulate composition of claim 1 wherein particles (A) and particles (B) both have average diameters in the range of 250-1500 μm, particularly 500-710 μm.

7. The particulate composition of claim 1 wherein the particles (A) have a delayed-release coating comprising a hydrophobic substance and a water-insoluble substance.

8. The particulate composition of claim 7 wherein the hydrophobic substance is a fat, wax or paraffin.

9. The particulate composition of claim 7 wherein the water-insoluble substance is titanium dioxide, calcium carbonate or kaolin.

10. The particulate composition of claim 1 wherein particles (B) are uncoated or are coated with a water-soluble polymer.

11. The particulate composition of claim 1 wherein the water-soluble polymer comprises polyethylene glycol (PEG), polyvinyl alcohol (PVA) or hydroxypropyl methyl cellulose (HPMC).

12. The particulate composition of claim 1 wherein the enzyme-containing particles (A) have a time for 50% release of enzyme in detergent solution at 20° C. of at least 300 seconds.

13. The particulate composition of claim 1 wherein the enzyme is a protease, an amylase, a lipase or a cellulase.

14. A particulate bleach-containing detergent composition comprising the particulate composition of claim 1.
